(19) United States
(12) Patent Application Publication
(10) Pub. No.: US 2026/0188675 A1
(43) Pub. Date: Jul. 2, 2026

(54) CATHODE ACTIVE MATERIAL INCLUDING FLUORINATED CARBON-BASED MONOMOLECULAR COMPOUND COATING LAYER, CATHODE INCLUDING SAME, ALL-SOLID- STATE BATTERY INCLUDING SAME, AND METHOD FOR MANUFACTURING CATHODE ACTIVE MATERIAL

(71) Applicant: POSTECH Research and Business Development Foundation, Pohang-si (KR)

(72) Inventors: Sang-Min LEE, Pohang-si (KR); Chanmyeong Kim, Pohang-si (KR)

(73) Assignee: POSTECH Research and Business Development Foundation, Pohang-si (KR)

(21) Appl. No.: 19/436,358

(22) Filed: Dec. 30, 2025

(30) Foreign Application Priority Data
Jan. 2, 2025 (KR) 10-2025-0000493
Oct. 30, 2025 (KR) 10-2025-0160303

(51) Int. Cl. H01M 4/583; H01M 4/02; H01M 4/36; H01M 10/0562

(52) U.S. Cl. CPC H01M 4/5835; H01M 4/366; H01M 10/0562; H01M 2004/028; H01M 2300/008

(57) ABSTRACT

Provided herein are a cathode active material, a cathode including same, an all-solid-state battery using same, and a manufacturing method therefor, wherein the cathode active material comprises: a cathode active material particle capable of intercalating and deintercalating lithium ions; and a monomolecular compound attached to a surface of the cathode active material particle, wherein the monomolecular compound includes a functional group containing F, a spacer comprising CₓF₂ₓ (6≤x≤12) or CₓF₂ₓ₋₄H₄ (6≤x≤12), and a reactive group containing P or Si.

### CROSS-REFERENCE TO RELATED APPLICATION(S)

This application is based on and claims priority under 35 U.S.C. 119 to Korean Patent Application No. 10-2025-0000493, filed on Jan. 2, 2025, and Korean Patent Application No. 10-2025-0160303, filed on Oct. 30, 2025, in the Korean Intellectual Property Office, the disclosure of which is herein incorporated by reference in its entirety.

### BACKGROUND OF THE INVENTION

### 1. Field of the Invention

The present disclosure relates to a cathode active material for an all-solid-state battery, the cathode active material including a fluorinated carbon-based monomolecular compound coating layer for preventing electrochemical performance degradation and thermal runaway, a cathode including same, an all-solid-state battery including same, and a method for manufacturing such a cathode active material.

### 2. Description of the Prior Art

All-solid-state batteries have attracted attention as next-generation secondary batteries from the viewpoints of resolving safety issues such as leakage or overheating, and achieving high energy density, high output, and long cycle life. An all-solid-state battery includes a cathode layer, a solid electrolyte layer, and an anode layer, and among them, the solid electrolyte layer requires high ionic conductivity and low electronic conductivity.

In general, cathode active materials for secondary batteries employ layered oxide cathode materials such as LiCoO₂, NCM523, and NCM811. Recently, in order to increase the energy density of cathode materials, NCM811 or Ni-rich layered oxide (NRLO) cathode materials having a reduced Co content and an increased Ni content of 90% or more have been used.

The reactivity between the solid electrolyte and the cathode active material in the cathode layer is a major factor that significantly deteriorates the electrochemical performance of all-solid-state batteries. During charge and discharge of an all-solid-state battery, transition metal cations diffuse between the solid electrolyte and the cathode active material, increasing interfacial resistance and degrading the material.

In addition, NRLO cathode materials have an issue of low structural stability in the charged state. When exposed to external shock or high-temperature environments, oxygen involved in the crystal structure of NRLO is released in the form of gas. This instability becomes a cause of thermal runaway in sulfide solid-electrolyte (SSE)-based all-solid-state batteries.

However, thermal runaway of sulfide-based all-solid-state batteries is not caused solely by oxygen release from NRLO. Thermal runaway is also triggered by structural destabilization of NRLO induced by cross-talk interactions between sulfide solid electrolytes and NRLO cathode materials, and the resulting promotion of oxygen release from NRLO.

Cross-talk between NRLO and the sulfide solid electrolyte is mediated by O₂ gas and SO₂ gas. When thermal shock occurs due to external heat shock or short circuiting inside an all-solid-state battery, NRLO generates O₂ gas. The O₂ gas then undergoes an oxidative decomposition reaction with LPSCl (Li₆PS₅Cl, lithium phosphorus sulfur chloride) present around NRLO to generate SO₂ gas. The SO₂ gas reacts with NRLO, penetrates the NRLO surface and grain boundaries, and at those regions, Li ions are deintercalated from NRLO to form substances such as Li₂SO₄.

Through such cross-talk mechanisms, NRLO becomes structurally destabilized due to lithium deintercalation and releases oxygen in even larger quantities. The large amount of oxygen induces a vigorous oxidative decomposition reaction of LPSCl. Since this oxidative decomposition is exothermic, rapid decomposition triggered by abundant oxygen supply leads to the onset of thermal runaway.

The thermal runaway phenomenon caused by the cross-talk described above originates from O₂ gas produced from NRLO and SO₂ gas produced from LPSCl. Therefore, it is necessary to introduce a coating layer on the surface of the cathode material that can block such gases to improve the thermal-runaway stability of all-solid-state batteries.

However, conventional cathode coating technologies have been implemented for improving the electrochemical performance of all-solid-state batteries, rather than for suppressing thermal runaway. Such coating layers are mainly composed of ion-conductive oxides, and sol-gel coating methods are used.

However, the sol-gel coating method includes expensive elements such as rare-earth metals or comparable high-cost elements as coating precursors. In addition, the coating process requires heat treatment at high temperatures of 500° C. or higher, resulting in high process complexity and high process cost. There is also a high probability of local defects (island-like defects), and thus cross-talk mediated by gas penetration of O₂ or SO₂ cannot be effectively suppressed.

### SUMMARY OF THE INVENTION

An aspect of the present disclosure is to provide a cathode active material for an all-solid-state battery, the cathode active material including a coating layer for preventing electrochemical performance degradation and thermal runaway.

Another aspect of the present disclosure is to provide a cathode including such a cathode active material and an all-solid-state battery including same.

Provided according to an embodiment of the present disclosure is a cathode active material comprising: a cathode active material particle capable of intercalating and deintercalating lithium ions; and a monomolecular compound adhered to a surface of the cathode active material particle, wherein the monomolecular compound comprises: a functional group containing F; a spacer including CₓF₂ₓ (6≤x≤12) or CₓF₂ₓ₋₄H₄ (6≤x≤12); and a reactive group containing P or Si.

An embodiment of the present disclosure provides the cathode active material wherein the CₓF₂ₓ or CₓF₂ₓ₋₄H₄ may satisfy the condition of 8≤x≤10.

An embodiment of the present disclosure provides the cathode active material wherein the CₓF₂ₓ may comprise at least one selected from C₈F₁₆, C₉F₁₈, C₁₀F₂₀, C₁₁F₂₂, and C₁₂F₂₄.

An embodiment of the present disclosure provides the cathode active material wherein the CₓF₂ₓ₋₄H₄ may comprise at least one selected from C₈H₄F₁₂, C₉H₄F₁₄, C₁₀H₄F₁₆, C₁₁H₄F₁₈, and C₁₂H₄F₂₀.

An embodiment of the present disclosure provides the cathode active material wherein the monomolecular compound forms a self-assembled monolayer, and a van der Waals force between the monomolecular compounds is 32 kJ/mol or more and kJ/mol or less.

Provided according to an embodiment of the present disclosure is a cathode for an all-solid-state battery, comprising a cathode active material and a conductive material, wherein the cathode active material is the cathode active material according to any one of Claims 1 to 5.

An embodiment of the present disclosure provides the cathode further comprising a cathode current collector.

Provided according to an embodiment of the present disclosure is an all-solid-state battery comprising a cathode, an anode, and a solid electrolyte layer, wherein the cathode comprises the cathode active material according to any one of Claims 1 to 5.

An embodiment of the present disclosure provides the all-solid-state battery wherein the solid electrolyte layer comprises a sulfide solid electrolyte.

Provided according to an embodiment of the present disclosure is a method for manufacturing a cathode active material, the method comprising: (A) mixing CₓF₂ₓ₊₁OH (6≤x≤12) or CₓF₂ₓ₋₃H₅OH (6≤x≤12) with an aprotic polar solvent; (B) mixing a reagent for imparting anchoring properties with the mixture of step (A) to generate a monomolecular compound; (C) mixing the monomolecular compound with a solvent to form a self-assembled monolayer coating solution; and (D) mixing the self-assembled monolayer coating solution with cathode active material powder.

An embodiment of the present disclosure provides the method for manufacturing a cathode active material, wherein the spacer of the monomolecular compound comprises at least one selected from C₈F₁₆, C₉F₁₈, C₁₀F₂₀, C₁₁F₂₂, C₁₂F₂₄, C₈H₄F₁₂, C₉H₄F₁₄, C₁₀H₄F₁₆, C₁₁H₄F₁₈, and C₁₂H₄F₂₀.

An embodiment of the present disclosure provides the method for manufacturing a cathode active material, wherein the aprotic polar solvent comprises at least one selected from tetrahydrofuran (THF), dimethylformamide (DMF), acetonitrile, and dimethyl sulfoxide (DMSO).

An embodiment of the present disclosure provides the method for manufacturing a cathode active material, wherein the reagent comprises at least one selected from phosphoryl chloride (POCl₃), KMnO₄, pyridinium chlorochromate, TEMPO (2,2,6,6-tetramethylpiperidine), and a mixed reagent of CrO₃/H₂SO₄.

An embodiment of the present disclosure provides the method for manufacturing a cathode active material, wherein step (B) is performed at a temperature of 0 to 100° C.

An embodiment of the present disclosure provides the method for manufacturing a cathode active material, wherein is 15 to 20 mL of the aprotic polar solvent, 300 to 500 mg of the CₓF₂ₓ₊₁OH or CₓF₂ₓ₋₃H₅OH, and 150 mg to 6 g of the reagent are mixed.

An embodiment of the present disclosure provides the method for manufacturing a cathode active material, wherein when the CₓF₂ₓ₊₁OH or CₓF₂ₓ₋₃H₅OH and the reagent are used in amounts of n and m mols, respectively, n/m is 0.5 or less.

An embodiment of the present disclosure provides the method for manufacturing a cathode active material, wherein, in step (C), the monomolecular compound is mixed at a concentration of 0.001 to 100 mM with the solvent.

An embodiment of the present disclosure provides the method for manufacturing a cathode active material, wherein the solvent of step (C) is THF or a mixed solvent of isopropyl alcohol and an alkane.

An embodiment of the present disclosure provides the method for manufacturing a cathode active material, wherein the alkane comprises at least one selected from hexane (C₆H₁₄), heptane (C₇H₁₆), octane (C₈H₁₈), nonane (C₉H₂₀), decane (C₁₀H₂₂), undecane (C₁₁H₂₄), and dodecane (C₁₂H₂₆) According to embodiments of the present disclosure, thermal runaway of an all-solid-state battery can be prevented.

In addition, according to embodiments of the present disclosure, the interfacial resistance between the cathode and the solid electrolyte can be reduced, thereby improving the electrochemical performance of an all-solid-state battery.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a cross-sectional view illustrating the structure of an all-solid-state battery according to an embodiment of the present disclosure;

FIG. 2 is a schematic view illustrating a self-assembled monolayer applied to a substrate according to an embodiment of the present disclosure;

FIG. 3 is a schematic cross-sectional view illustrating a self-assembled monolayer applied to a cathode active material particle according to an embodiment of the present disclosure;

FIG. 4 is a set of photographic images showing TEM-EELS analysis results of a comparative example;

FIG. 5 is a graph showing XRD analysis results of a comparative example;

FIG. 6 is a set of views showing XPS analysis results for a cathode active material particle according to an embodiment of the present disclosure;

FIG. 7 is a set of photographic images showing TEM analysis results for a cathode active material particle according to an embodiment of the present disclosure;

FIG. 8 is a graph comparing coulombic efficiency and capacity retention between an embodiment of the present disclosure and a comparative example;

FIG. 9 is a graph comparing EIS analysis results between an embodiment of the present disclosure and a comparative example;

FIG. 10 is a graph comparing DRT conversion results between an embodiment of the present disclosure and a comparative example;

FIG. 11 is a set of photographic images showing FIB-TEM/EELS analysis results of an all-solid-state battery according to an embodiment of the present disclosure after charge and discharge;

FIG. 12 is a set of graphs showing XPS analysis results before and after charge/discharge of an all-solid-state battery according to an embodiment of the present disclosure.

FIG. 13 is a set of photographic images comparing thermal shock test results between an embodiment of the present disclosure and a comparative example;

FIG. 14 is a set of photographic images showing TEM analysis results for a composite of a comparative example.

FIG. 15 is a set of photographic images showing FFT transformation of a TEM image of a composite of a comparative example;

FIG. 16 is a set of photographic images showing TEM analysis results for a composite according to an embodiment of the present disclosure;

FIG. 17 is a set of photographic images showing FFT transformation of a TEM image of a composite according to an embodiment of the present disclosure;

FIG. 18 is a flowchart illustrating a method of manufacturing a cathode active material according to an embodiment of the present disclosure;

FIG. 19 is a graph showing coulombic efficiency and capacity retention of another comparative example;

FIG. 20 is a graph showing EIS analysis results of another comparative example; and

FIG. 21 is a graph comparing DRT conversion results of another comparative example.

### DETAILED DESCRIPTION OF THE EXEMPLARY EMBODIMENTS

Hereinafter, embodiments disclosed in the present specification will be described in detail with reference to the accompanying drawings. Throughout the drawings, like reference numerals refer to like or similar elements, and repeated descriptions thereof will be omitted. In the description of the embodiments according to the present disclosure, when each layer (film), region, pattern, or structure is described as being formed “on” or “under” a substrate, another layer (film), region, pattern, or structure, the terms “on” and “under” are intended to include both being formed directly and being formed indirectly with another layer interposed therebetween. The criteria for “on” and “under” of each layer are defined based on the drawings. The thicknesses or sizes of the layers in the drawings may be exaggerated, omitted, or schematically illustrated for the sake of clarity and convenience of description. The sizes of the respective components do not necessarily reflect actual sizes.

In the present description, expressions such as “include,” “comprise,” or “have” are intended to designate the presence of the stated features, numerals, steps, operations, elements, parts, or combinations thereof, and are not to be construed as excluding the possibility of the presence or addition of one or more other features, numerals, steps, operations, elements, parts, or combinations thereof.

In addition, terms such as “first,” “second,” and the like may be used to describe various elements, but such elements are not limited by these terms, and the terms are used merely to distinguish one element from another.

Further, in describing the embodiments disclosed in the present specification, detailed descriptions of related known technologies may be omitted when it is determined that such descriptions may obscure the gist of the embodiments disclosed herein.

The accompanying drawings are provided merely to aid understanding of the embodiments disclosed in the present specification, and the technical spirit disclosed herein should not be construed as being limited thereto. It is to be understood that all modifications, equivalents, and substitutions within the scope of the claims are included in the spirit and scope of the present disclosure.

As used herein, the term “about” denotes a typical tolerance range for each value readily understood by those skilled in the art. The term “about” may refer to within ±5% of the specified value.

Hereinafter, a detailed description will be given of the present disclosure with reference to the drawings.

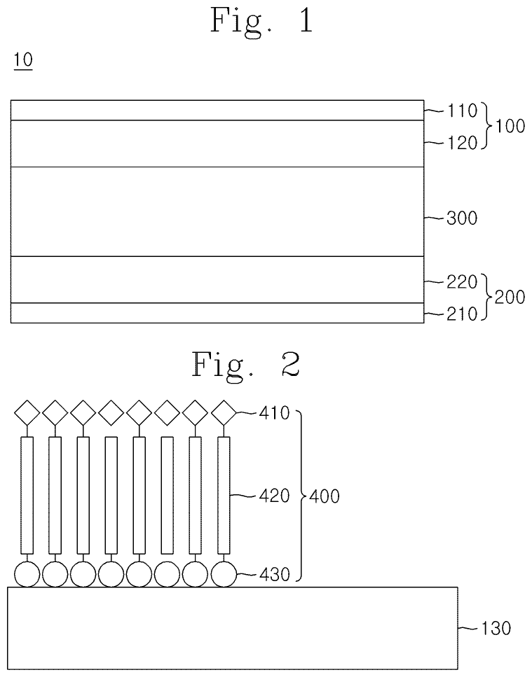

FIG. 1 is a cross-sectional view illustrating the structure of an all-solid-state battery according to an embodiment of the present disclosure.

An all-solid-state battery 10 according to an embodiment of the present disclosure includes a cathode layer 100, an anode layer 200, and a solid electrolyte layer 300. The solid electrolyte layer 300 is disposed between the cathode layer 100 and the anode layer 200. The cathode layer 100 includes a cathode current collector 110 and a cathode active material layer 120, and the cathode active material layer 120 is disposed on the cathode current collector 110. The anode layer 200 includes an anode current collector 210 and an anode active material layer 220, and the anode active material layer 220 is disposed on the anode current collector 210.

### [Anode Layer]

The anode active material layer 220 may include lithium (Li) metal, a lithium metal alloy, or a combination thereof. Alternatively, the anode active material layer 220 may include at least one selected from the group consisting of a metal capable of alloying with lithium, a transition metal oxide, a non-transition metal oxide, and a carbon-based material. For example, the anode active material layer 220 may be in the form of a plate or a foil.

Examples of metals capable of alloying with lithium include Ag, Si, Sn, Al, Ge, Pb, Bi, Sb, Si—Y alloys (where Y is an alkali metal, an alkaline earth metal, a group 13 element, a group 14 element, a transition metal, a rare earth element, or a combination thereof, but is not Si), Sn—Y alloys (where Y is an alkali metal, an alkaline earth metal, a group 13 element, a group 14 element, a transition metal, a rare earth element, or a combination thereof, but is not Sn), and the like. The element Y may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or combinations thereof.

Examples of transition metal oxides include lithium titanium oxides, vanadium oxides, and lithium vanadium oxides. Examples of non-transition metal oxides include SnO₂ and SiOₓ (0<x<2). The carbon-based material may be crystalline carbon, amorphous carbon, or a mixture thereof. Crystalline carbon may be graphite such as natural graphite or artificial graphite in amorphous, plate-like, flake, spherical, or fibrous form, and amorphous carbon may include soft carbon (low-temperature calcined carbon), hard carbon, mesophase pitch carbon, calcined coke, and the like. The anode active material layer 220 may be 10-30 μm in thickness.

The anode current collector 210 may be formed of a material that does not react with lithium. Specifically, the anode current collector 210 may be formed of a material that does not form an alloy or compound with lithium. Examples of materials constituting the anode current collector 210 include copper (Cu), stainless steel, titanium (Ti), iron (Fe), cobalt (Co), and nickel (Ni), but are not limited thereto, and any material generally used as an anode current collector may be used.

The anode current collector 210 may be formed of one of the above-described metals, or an alloy or clad material of two or more of the metals. For example, the anode current collector 210 may be in the form of a plate or a foil. The thickness of the anode current collector 210 may be 8-10 μm.

### [Solid Electrolyte Layer]

The solid electrolyte layer 300 includes a solid electrolyte and is disposed between the cathode layer 100 and the anode layer 200. The solid electrolyte included in the solid electrolyte layer 300 may be a sulfide-based, oxide-based, halide-based, or polymer-type solid electrolyte.

Examples of oxide-based solid electrolytes include perovskite-type LLTO (Li₃ₓLa_{2/3-x}TiO₃) and NASICON-type LATP (Li₁₊ₓAlₓTi₂₋ₓ(PO₄)₃).

Examples of sulfide-based solid electrolytes include Li₂S—P₂S₅, Li₂S—P₂S₅—LiX (X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive integers, Z is Ge, Zn, or Ga), Li₂S—GeS₂, Li₂S—SiS₂—Li₃PO₄, Li₂S—SiS₂-LiₚMO_{q} (p and q are positive integers, M is P, Si, Ge, B, Al, Ga, or In), Li₇₋ₓPS₆₋ₓClₓ (0≤x≤2), Li₇-xPS₆-xBrₓ (0≤x≤2), and Li₇-xPS₆-xIₓ (0≤x≤2).

The sulfide-based solid electrolyte may be an argyrodite-type compound including at least one selected from Li₇₋ₓPS₆₋ₓClₓ (0≤x≤2), Li₇-xPS₆-xBrₓ (0≤x≤2), and Li₇-xPS₆-xIₓ (0≤x≤2). The sulfide-based solid electrolyte may include at least one selected from Li₆PS₅Cl, Li₆PS₅Br, and Li₆PS₅I.

Sulfide-based solid electrolytes are sensitive to moisture and generate corrosive gases such as hydrogen sulfide even in environments containing moisture at the level of several tens of ppm. If such corrosive gases are generated during the manufacturing or charge-discharge cycling of an all-solid-state battery, the corrosive gas reacts with the copper foil anode current collector to form copper sulfide on the surface of the anode current collector. This corrosion reaction deteriorates the mechanical and electrochemical properties of the anode current collector, resulting in increased internal resistance of the all-solid-state battery. When internal resistance increases, the reversible capacity decreases, thereby degrading the cycle-life characteristics.

### [Cathode Layer]

The cathode current collector 110 may be, for example, a plate or foil made of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

The cathode active material layer 120 may include, for example, a cathode active material 130 and a solid electrolyte. The solid electrolyte included in the cathode layer 100 may be the same as or different from the solid electrolyte included in the solid electrolyte layer 300.

The cathode active material or cathode active material particles 130 can intercalate and deintercalate lithium ions. The cathode active material 130 may be any material capable of intercalating and deintercalating lithium ions. The cathode active material 130 may preferably be a lithium transition metal oxide, and may be, for example, lithium cobalt oxide (LCO), lithium nickel oxide, lithium nickel cobalt oxide, lithium nickel cobalt aluminum oxide (NCA), lithium nickel cobalt manganese oxide (NCM), lithium manganese oxide, or lithium iron phosphate, and the like.

The lithium transition metal oxide may be selected from the group consisting of LiCoO₂, LiNiO, LiMnO₂, LiMn₂O₄, Li(NiₐCo_{b}Mn_{c})O₂ (0<a<1, 0<b<1, 0<c<1, a+b+c=1), Li(NiₐCo_{b}Al_{c})O₂ (0<a<1, 0<b<1, 0<c<1, a+b+c=1), LiNi_{1-y}Co_{y}O₂ (0≤y<1), LiCo_{1-y}Mn_{y}O₂ (0≤y<1), LiNi_{1-y}Mn_{y}O₂ (0≤y<1), LiMn_{2-z}Ni_{z}O₄ (0<z<2), LiMn_{2-z}Co_{z}O₄ (0<z<2), and combinations thereof.

In addition, the cathode active material 130 may be nickel sulfide, copper sulfide, lithium sulfide, iron oxide, or vanadium oxide, and the like, but is not necessarily limited thereto, and any material that is used as a cathode active material in the relevant technical field may be used. Each cathode active material may be used alone, or two or more may be used in combination.

The cathode active material layer 120 may include a conductive material. Examples of the conductive material include graphite, carbon black, acetylene black, Ketjen black, carbon fibers, and metal powders.

The average particle diameter of the cathode active material particles 130 is not particularly limited. For example, the average particle diameter of the cathode active material 130 may be 1 μm to 20 μm, or 5 μm to 15 μm. The thickness of the cathode current collector 110 may be 8-10 μm, and the thickness of the cathode active material layer 120 may be 80-110 μm.

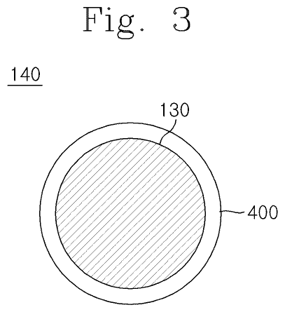

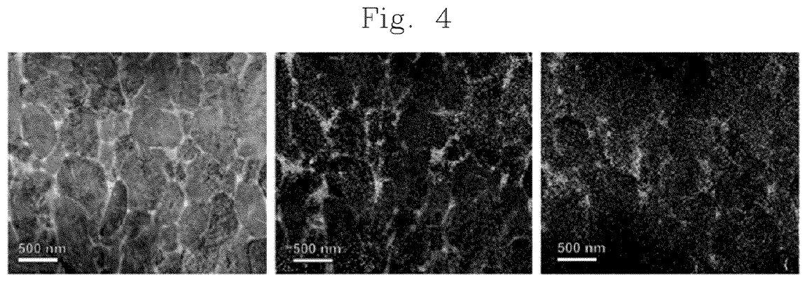

FIG. 2 is a schematic view illustrating a self-assembled monolayer applied to a substrate according to an embodiment of the present disclosure, and FIG. 3 is a cross-sectional view schematically illustrating a self-assembled monolayer applied to a cathode active material particle according to an embodiment of the present disclosure.

In the cathode active material particles 130 according to an embodiment of the present disclosure, a fluorocarbon-based self-assembled monolayer (SAM) 400 is applied. The self-assembled monolayer 400 is an ordered organic molecular film that is spontaneously coated on the surface of a given substrate 130.

Since the self-assembled monolayer 400 has thermodynamically spontaneous self-assembly and surface-attachment characteristics, it can be coated on the surface layer of a specific substrate very uniformly and without defects. In an embodiment of the present disclosure, the substrate may be the cathode active material particles 130. The self-assembled monolayer coating layer 400 according to an embodiment of the present disclosure allows conduction of lithium ions while preventing diffusion of transition metal cations.

In an embodiment of the present disclosure, a fluorocarbon-based self-assembled monolayer 400 is applied to the cathode active material particles 130, thereby suppressing interaction caused by O₂ generated from the cathode active material particles 130 and SO₂ generated from the solid electrolyte, and thus preventing thermal runaway.

Referring to FIGS. 2 and 3, a monomolecular species forming the self-assembled monolayer 400 includes a functional group 410, a spacer 420, and a reactive group 430. The functional group 410 may be referred to as a terminal group, and the reactive group 430 may be referred to as a head group or an anchor.

The functional group 410 is a tail portion of the molecule that determines the function of the self-assembled monolayer 400. The functional group 410 includes hydrogen (H), fluorine (F), or carbon (C), and provides chemical stability so that the self-assembled monolayer 400 is not deteriorated by gases such as SO₂. The functional group 410 may be CF₃.

To minimize interaction with polar corrosive gas molecules such as SO₂, it is preferable that the functional group 410 is non-polar. Accordingly, the lower the polarity of the functional group 410 (that is, the smaller the dipole moment), the better its ability to block penetration of polar corrosive gas molecules. The low-polarity functional group 410 may include an alkyl group (CH₃, C₂H₅, C₃H₇, C₄H₉, C₅H₁₁, etc.), a cycloalkyl group (cyclopropyl, cyclobutyl, cyclopentyl, cyclohexyl, etc.), or an aryl group (phenyl, benzyl, naphthyl, etc.).

When the functional group 410 includes fluorine (F), the C—F bond of the self-assembled monolayer 400 itself is polar, but the arrangement of F is symmetrical in view of the entire molecule, and thus the self-assembled monolayer 400 is non-polar.

The spacer 420 is a backbone portion of the molecule that enables the formation of a regular molecular film. The spacer 420 has a structure including carbon and fluorine, or a structure including carbon, fluorine, and hydrogen, and has a molecular formula of CₓF₂ₓ or CₓF₂ₓ₋₄H₄. The spacer 420 provides van der Waals forces, which are intermolecular interactions, so that the self-assembled monolayer coating layer 400 is uniformly applied. In addition, the spacer 420 has a property of blocking penetration of SO₂ gas.

To form a uniform self-assembled monolayer 400, the van der Waals force generated between molecules forming the monomolecular film may be 32 kJ/mol or more and 40 kJ/mol or less. When the van der Waals force is less than 32 kJ/mol, self-assembly may not be uniform and the self-assembled monolayer may not be formed uniformly. When the van der Waals force exceeds 40 kJ/mol, aggregation may occur due to strong van der Waals forces, making it difficult to form a monomolecular coating layer.

The van der Waals interaction between molecules is determined by the composition of the molecule, the length of the molecule, and the like. In this case, the length of the molecule may be determined by x in CₓF₂ₓ or CₓF₂ₓ₋₄H₄. In an embodiment of the present disclosure, 2≤x≤20 or 6≤x≤12, and preferably 8≤x≤10. When 8≤x≤10, an appropriate magnitude of van der Waals force can be obtained even though the molecule is short in length due to its high electronegativity. CₓF₂ₓ may be at least one selected from C₈F₁₆, C₉F₁₈, C₁₀F₂₀, C₁₁F₂₂, and C₁₂F₂₄, and CₓF₂ₓ₋₄H₄ may be at least one selected from C₈H₄F₁₂, C₉H₄F₁₄, C₁₀H₄F₁₆, C₁₁H₄F₁₈, and C₁₂H₄F₂₀.

The reactive group 430 is a head portion of the molecule that bonds to a substrate such as the cathode active material particles 130. The reactive group 430 includes phosphorus (P) or silicon (Si), and has a characteristic of strongly attaching to the surface of the cathode active material particles 130. The reactive group 430 may be PO₄H₂, Si(OCH₃)₃, or Si(OH)₃, and the like. The reactive group 430 may be a ligand.

An oxygen atom of a phosphorus-containing reactive group (phosphate group) forms a tetrahedron, and the P atom at a tetrahedral site can induce an inductive effect. Thus, ionicity between metal atoms of a current collector (for example, an anode current collector) and molecules of the self-assembled monolayer 400 can be enhanced, and a stronger bond can be induced.

Examples of reactive groups that can strengthen bonding to the current collector by the inductive effect include SO₄²⁻, PO₄³, and SiO⁴⁻. In this case, the inductive effect is induced more strongly in the order of SiO⁴⁻<PO₄³<SO₄²⁻.

Hereinafter, a method of manufacturing the self-assembled monolayer 400 according to an embodiment of the present disclosure will be described.

First, a primary alcohol containing a fluorocarbon is mixed with an aprotic polar solvent to prepare a solution (first solution). The primary alcohol containing a fluorocarbon may be CₓF₂ₓ₊₁OH or CₓF₂ₓ₋₃H₅OH. In this case, 2≤x≤20 or 6≤x≤12, and preferably 8≤x≤10.

The primary alcohol containing a fluorocarbon may be, for example, a fluoroalcohol such as C₈F₁₇OH(Perfluoro-1-octanol), C₈H₅F₁₃O(1H,1H,2H,2H-Perfluoro-1-octanol), C₉F₁₉OH(Perfluoro-1-nonanol), C₉H₅F₁₅O(1H,1H,2H,2H-Perfluoro-1-nonanol), C₁₀F₂₁OH(Perfluoro-1-decanol), C₁₀H₅F₁₇O(1H,1H,2H,2H-Perfluoro-1-decanol), C₁₁F₂₃OH(Perfluoro-1-undecanol), C₁₂H₅F₁₉O(1H,1H,2H,2H-Perfluoro-1-undecanol), C₁₂F₂₅OH(Perfluoro-1-dodecanol), or C₁₂H₅F₂₁O(1H,1H,2H,2H-Perfluoro-1-dodecanol).

The aprotic polar solvent may be THF (tetrahydrofuran), DMF (dimethylformamide), acetonitrile, or DMSO (dimethyl sulfoxide).

Subsequently, a reagent is injected into the first solution at a temperature of 0-100° C. The reagent may be POCl₃ (phosphoryl chloride), KMnO₄, pyridinium chlorochromate, TEMPO (2,2,6,6-tetramethylpiperidine), or a mixed reagent of CrO₃/H₂SO₄, and the like. Preferably, the reagent may contain phosphorus (P). More preferably, the reagent may be POCl₃ (phosphoryl chloride). The reagent may function to oxidize an alcohol group (—OH) in the molecule. When the alcohol is oxidized by such a reagent, the molecule may have an anchor property that allows it to attach to the surface of a substrate.

Fifteen to 20 mL of the aprotic polar solvent, 300-500 mg of the primary alcohol containing a fluorocarbon, and 150 mg-6 g of the reagent may be mixed. In this case, the number of molecules of the fluorocarbon-containing hydrocarbon may be smaller than the number of molecules of the reagent. When the primary alcohol containing a fluorocarbon is used in an amount of n mol and the reagent is used in an amount of m mol, n/m may be 1 or less. Preferably, the molar ratio n/m may be 0.5 or less. For example, when using THF as the aprotic polar solvent, C₁₀H₅F₁₇O as the primary alcohol, and POCl₃ as the reagent, the molar ratio of C₁₀H₅F₁₇O to POCl₃ may be 1 or less, or 0.5 or less.

As described above, a monomolecular coating material or monomolecular compound for a monolayer film can be obtained through nucleophilic attack of an alcohol group, resulting in esterification. This will be described in more detail below.

To synthesize a self-assembled monomolecular compound according to an embodiment of the present disclosure, a primary alcohol is used as a precursor. The primary alcohol is dissolved in an aprotic polar solvent, and, through nucleophilic attack, a hydrogen atom of the primary alcohol is released and is substituted by POCl₃. Subsequently, Cl is removed, and the reactive group (PO₄H₂) is attached to the terminal of the precursor molecule.

The self-assembled monomolecular compound synthesized as described above is separated and purified through recrystallization and extraction processes, thereby obtaining a powder-type self-assembled monomolecular compound. The powder-type self-assembled monomolecular compound may be dissolved in a solvent at a concentration of 0.001-100 mM to prepare a self-assembled monomolecular coating solution.

In this case, the solvent may be THF or a mixed solvent of an alkane (CₓH₂ₓ₊₂) and an alcohol (C_{y}H_{(2y+2)}OH). The mixed solvent may be a mixed solvent including 99-100% v/v of the alkane and 0-1% v/v of the alcohol. The alkane may be hexane (C₆H₁₄), heptane (C₇H₁₆), octane (C₈H₁₈), nonane (C₉H₂₀), decane (C₁₀H₂₂), undecane (C₁₁H₂₄), or dodecane (C₁₂H₂₆), in which 6≤x≤12. The alcohol (C_{y}H_{(2y+1)}OH) may satisfy the condition of 1≤y≤4.

The cathode active material powder 130 is immersed in the self-assembled monomolecular coating solution for about 12 hours. Thereafter, the cathode active material powder 130 is vacuum-dried to obtain cathode active material powder 140 coated with the self-assembled monolayer. The reactive group (PO₄H₂) of the self-assembled monomolecule undergoes a dehydration-condensation reaction with OH functional groups on the surface of the cathode active material powder 130, whereby the self-assembled monomolecule is attached to the surface of the cathode active material powder 130.

The thickness of the self-assembled monolayer 400 according to an embodiment of the present disclosure is a thickness at which electrons can be conducted by a tunnel effect and at which passage of O₂ and SO₂ gases can be prevented. The thickness of the self-assembled monolayer 400 applied to the cathode active material particles 130 may be 2-4 nm. If the thickness of the self-assembled monolayer 400 is too small, the performance of preventing passage of O₂ and SO₂ gases may be degraded, and if the thickness is too large, the tunnel effect may not occur.

The thickness of the self-assembled monolayer 400 may be measured using TEM-EELS (transmission electron microscopy-electron energy-loss spectroscopy). In this case, the thickness of the F element in the cathode active material 140 coated with the self-assembled monolayer is measured to determine the thickness of the self-assembled monolayer 400.

Hereinafter, an interaction experiment between a cathode active material and SO₂ gas will be described.

### Comparative Example

In the comparative example, NCM811 without the self-assembled monolayer 400 coated thereon was used as the cathode active material.

To simulate SO₂ gas generated from the solid electrolyte LPSCl, sodium sulfite and sulfuric acid were reacted to generate SO₂ gas. To analyze the interaction between the SO₂ gas thus generated and NCM811, the NCM811 cathode active material was exposed to SO₂ at room temperature for about 6 hours in a sealed container having an SO₂ gas atmosphere.

The cross-section of the resulting NCM811 sample was then analyzed by FIB milling (focused ion beam milling), followed by analysis using TEM-EELS (transmission electron microscopy-electron energy-loss spectroscopy).

FIG. 4 is a photographic image showing the TEM-EELS analysis result of the comparative example.

Referring to FIG. 4, it can be seen that SO₂ has penetrated into the grain boundaries of NCM811. It can also be seen that lithium ions of NCM811 have been deintercalated by SO₂.

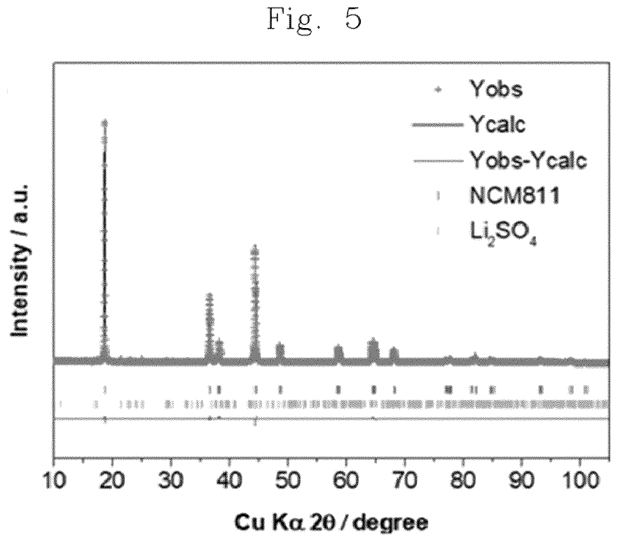

FIG. 5 is a graph showing the XRD analysis result of the comparative example.

Referring to FIG. 5, it can be confirmed, through XRD (X-ray diffraction) and Rietveld refinement analysis, that the deintercalated lithium ions are present in the form of Li₂SO₄.

Table 1 below shows the result of the Rietveld refinement analysis.

TABLE 1

| Classification | Result |
|---|---|
| Phase | Li₂SO₄ |
| Crystal system | Monoclinic |
| Space group | P 1 21 1 |
| a(Å)/b(Å)/c(Å) | 5.4539/4.8774/8.1808 |
| Phase fraction (wt. %) | 5.12 |
| R_{wp} (%) | 5.91 |
| Rₚ (%) | 7.37 |

### Example

In an example of the present disclosure, NCM811 coated with the self-assembled monolayer 400 was used as the cathode active material 140 and evaluated. The self-assembled monolayer 400 was coated on NCM811 particles 130 as described below.

First, C₁₀H₅F₁₇O (1H,1H,2H,2H-perfluoro-1-decanol) was mixed with an aprotic polar solvent, THF (tetrahydrofuran), to prepare a first solution. Thereafter, at 60° C., a reagent, POCl₃ (phosphoryl chloride), was injected into the first solution. At this time, 15 mL of THF, 500 mg of C₁₀H₅F₁₇O, and 6 g of the reagent POCl₃ were mixed.

The monomolecular compound powder thus prepared was dissolved in THF at a concentration of 10 mM to prepare a self-assembled monomolecular coating solution. NCM811 powder 130 was immersed in the self-assembled monomolecular coating solution for 12 hours and then vacuum-dried. The thickness of the self-assembled monolayer 400 applied to the NCM811 particles 130 was measured to be 3 nm.

### Other Comparative Example

In the above-described example, C₁₀H₅F₁₇O (1H,1H,2H,2H-perfluoro-1-decanol) was used as the precursor; however, in another comparative example, a self-assembled monolayer was formed using C₁₀H₂₁OH (1-decanol), which is a primary alcohol that does not contain fluorocarbon.

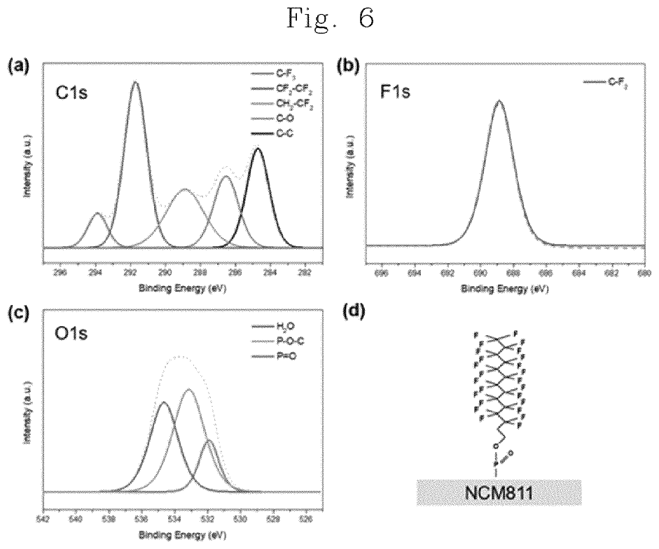

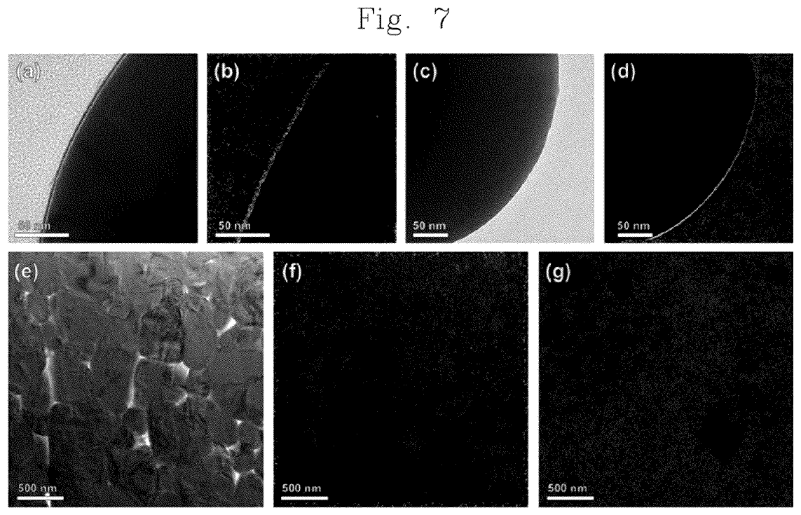

FIG. 6 illustrates the XPS analysis results for the cathode active material particles according to an embodiment of the present disclosure.

X-ray photoelectron spectroscopy (XPS) is a technique for determining the surface composition and chemical bonding states of a specimen by irradiating X-rays onto the surface and measuring the kinetic energy of the emitted photoelectrons.

Referring to FIG. 6, the XPS analysis of the cathode active material 140 coated with the self-assembled monolayer confirms the characteristic binding energies of the self-assembled monomolecular compound. With reference to a of FIG. 6, peaks corresponding to C—C and C—F bonds are observed in the C1s region. Turning to b of FIG. 6, a peak corresponding to C—F is observed in the F1s region. Referring to c of FIG. 6, peaks corresponding to P—O and P═O, which are attributable to the reactive (anchor) portion of the self-assembled monomolecular compound, are observed in the Ols region. As shown in d of FIG. 6, it is thus confirmed that the self-assembled monomolecules are coated on the surface of the NCM811 particles.

FIG. 7 illustrates the TEM analysis results for the cathode active material particles according to an embodiment of the present disclosure.

TEM-EELS analysis was performed to evaluate the uniformity of the self-assembled monolayer 400 coated on the cathode active material 130.

Referring to the TEM images in a and c of FIG. 7, the self-assembled monolayer 400 is shown to be uniformly coated. In addition, referring to the TEM-EELS mapping images in b and d of FIG. 7, the self-assembled monolayer 400 contains fluorine (F), and the coating thickness is uniformly about 3 nm.

e, f and g of FIG. 7 show FIB-TEM/EELS images obtained after exposing the cathode active material 140 coated with the self-assembled monolayer to SO₂ gas for 6 hours. In the cathode active material 140 coated with the self-assembled monolayer, SO₂ does not penetrate into the grain boundaries (see S-mapping in f of FIG. 7), and delithiation is not observed (see Li-mapping in g of FIG. 7). Therefore, it is confirmed that the self-assembled monolayer (400) prevents SO₂ gas penetration and suppresses lithium-ion delithiation.

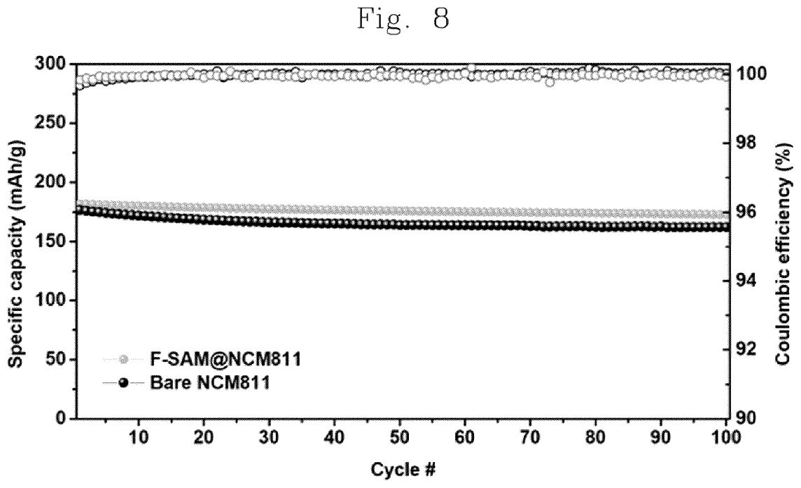

Below, referring to FIGS. 8 to 10, the electrochemical performance of the Comparative Example and the Example of the present disclosure is described.

To evaluate the electrochemical performance of the cathode active material 140 according to an embodiment of the present disclosure, an all-solid-state battery was fabricated using F-SAM-coated NCM811 (140), solid electrolyte Li₆PS₅Cl, and a lithium anode. As a result, the embodiment of the present disclosure (F-SAM@NCM811) exhibited superior electrochemical performance compared to the comparative example (Bare NCM811).

FIG. 8 is a graph comparing the coulombic efficiency and capacity retention of the Example of the present disclosure with those of the Comparative Example.

FIG. 8 shows the results of 100 charge/discharge cycles at a rate of 0.2 C. Referring to FIG. 8, the initial coulombic efficiency (I.C.E.) of the embodiment was 83.44%, whereas that of the Comparative Example was 80.41%. The capacity retention of the embodiment was 95.11%, whereas that of the comparative example was 91.77%. Thus, both the initial coulombic efficiency and the capacity retention of the embodiment were superior. The average coulombic efficiency (Avg. C.E.) was 99.9% for both the embodiment and the Comparative Example.

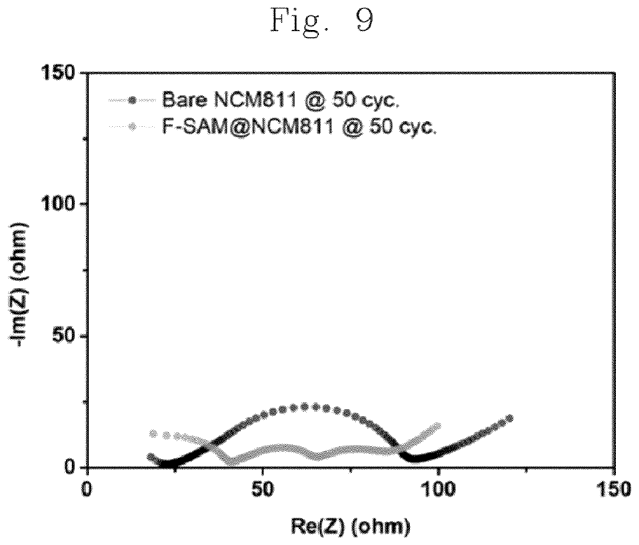

FIG. 9 is a graph comparing the EIS analysis results of the Example of the present disclosure and the Comparative Example.

Referring to FIG. 9, the electrochemical impedance spectroscopy (EIS) results indicate that the Example exhibits lower resistance than the Comparative Example. In addition, multiple semi-circles appear in the Example. To clearly interpret the impedance data obtained from EIS, DRT analysis was conducted.

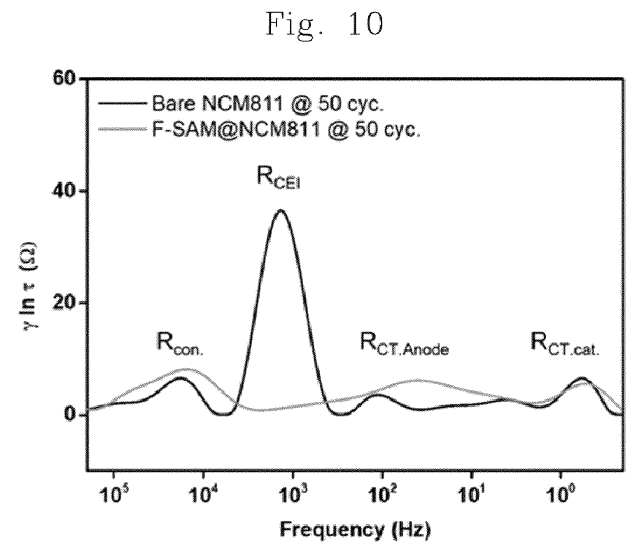

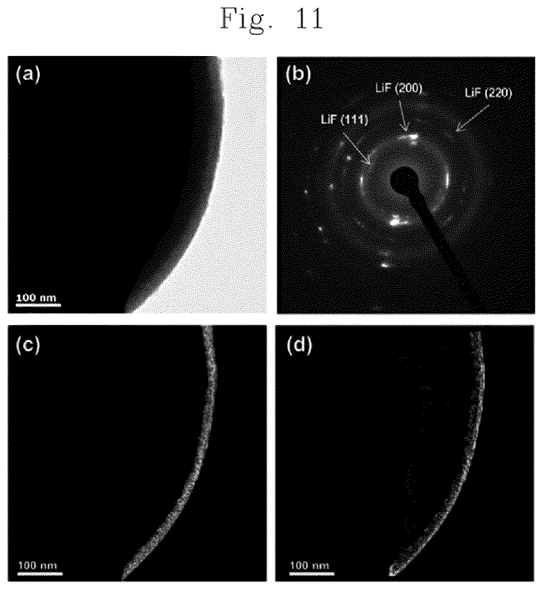

FIG. 10 is a graph comparing the DRT transformation results of the Example of the present disclosure and the Comparative Example.

Referring to FIG. 10, the resistance at the interface between the cathode active material (NCM811) and the solid electrolyte (LPSCl), i.e., R_{CEI}, is lower in the embodiment than in the comparative example. This is because the self-assembled monolayer (400) in the embodiment functions as a chemically stable ion-conductive coating layer at the interface between the cathode active material and the solid electrolyte.

In FIG. 10, R_{con} denotes the contact resistance, R_{CEI} denotes the interfacial resistance between the cathode active material and the solid electrolyte, R_{CT.Anode} denotes the charge-transfer resistance at the anode, and R_{CT.cat.} denotes the charge-transfer resistance at the cathode.

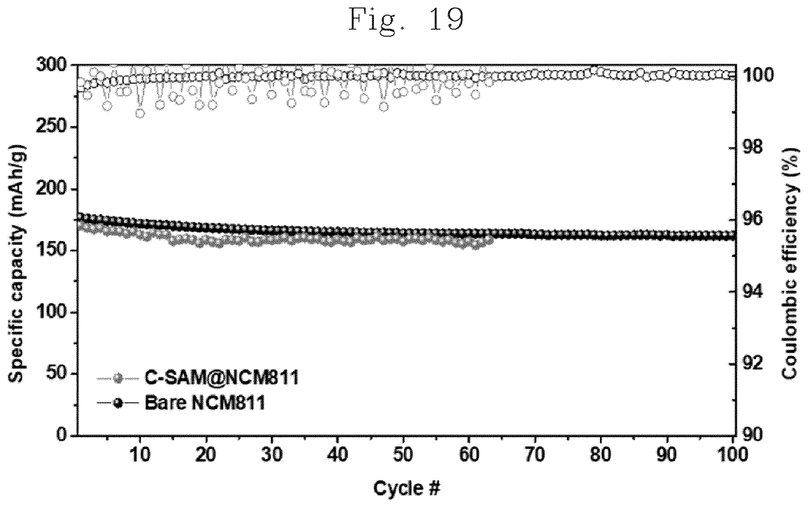

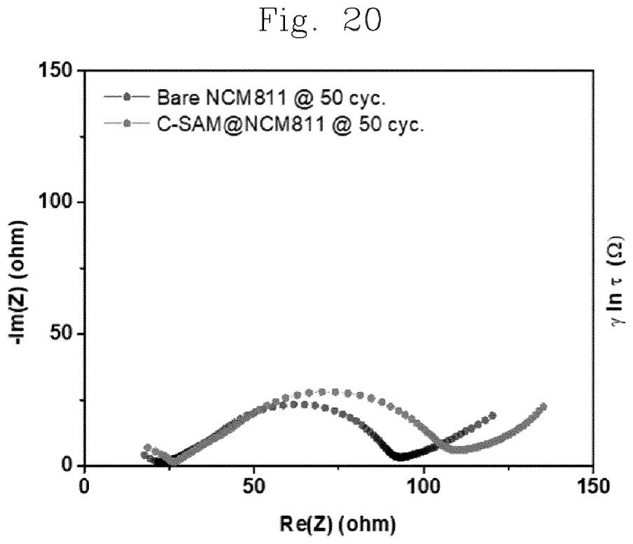

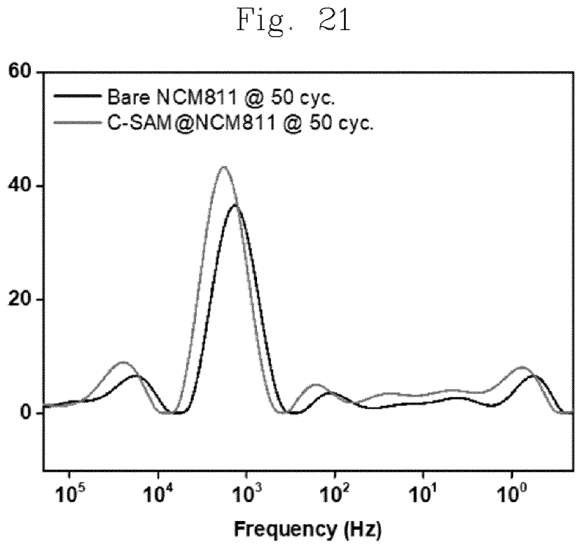

FIG. 19 is a graph showing the coulombic efficiency and capacity retention of another Comparative Example, FIG. 20 is a graph showing the EIS analysis results of another Comparative Example, and FIG. 21 is a graph comparing the DRT conversion results of another Comparative Example.

FIGS. 19 to 21 compare the performance of the Comparative Example (Bare NCM811) with that of another Comparative Example (C-SAM@NCM811). Referring to FIGS. 19 to 21, the other Comparative Example (C-SAM@NCM811) exhibits degraded electrochemical characteristics (initial coulombic efficiency, capacity retention, and resistance) relative to the Comparative Example (Bare NCM811). In particular, the interfacial resistance at the interface between the cathode active material and the solid electrolyte increases. This is because, in the other Comparative Example, a stable SEI (Solid Electrolyte Interphase) layer such as LiF cannot be formed.

FIG. 11 is a set of photographs showing the FIB-TEM/EELS analysis results of the all-solid-state battery after charging and discharging, according to an Example of the present disclosure.

As described above, an all-solid-state battery was fabricated using the cathode active material 140 according to an embodiment of the present disclosure, and after one charge-discharge cycle, the cell was disassembled and subjected to FIB-TEM/EELS analysis.

Referring to a of FIG. 11, it is observed that the self-assembled monolayer 400 is uniformly coated on the cathode active material particles 130. In addition, fluorine (F) (see EELS F-mapping in c of FIG. 11) and lithium (Li) (see EELS Li-mapping in d of FIG. 11) are detected in the self-assembled monolayer 400. From the SAED (selected area electron diffraction) analysis of the same region, LiF is detected in the layer (b of FIG. 11).

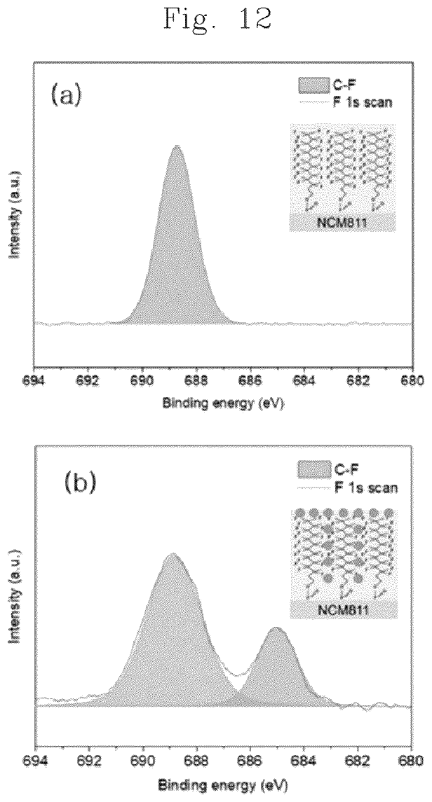

FIG. 12 shows graphs of the XPS analysis results of the all-solid-state battery before and after charging and discharging, according to an embodiment of the present disclosure.

a of FIG. 12 corresponds to the XPS results before the first charge-discharge cycle, and b of FIG. 12 corresponds to the results after the first charge-discharge cycle.

Referring to a of FIG. 12, LiF is not detected in the F1s region prior to charging/discharging. However, referring to b of FIG. 12, after one charge-discharge cycle, the binding energy corresponding to LiF is detected in the F1s region. Therefore, it is confirmed that the embodiment of the present disclosure forms LiF in situ during the electrochemical charge-discharge process. This indicates that the self-assembled monomolecules of the embodiment act as precursors for LiF formation. Because LiF is electrochemically stable and ionically conductive, such LiF formation enables the self-assembled monolayer 400 to enhance electrochemical performance.

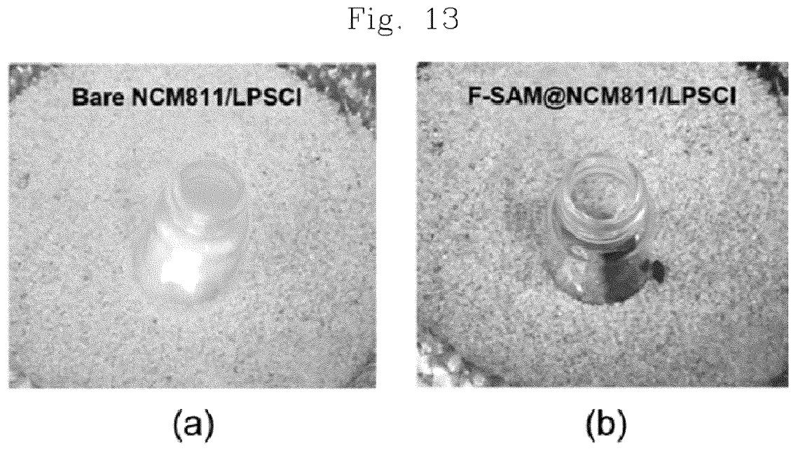

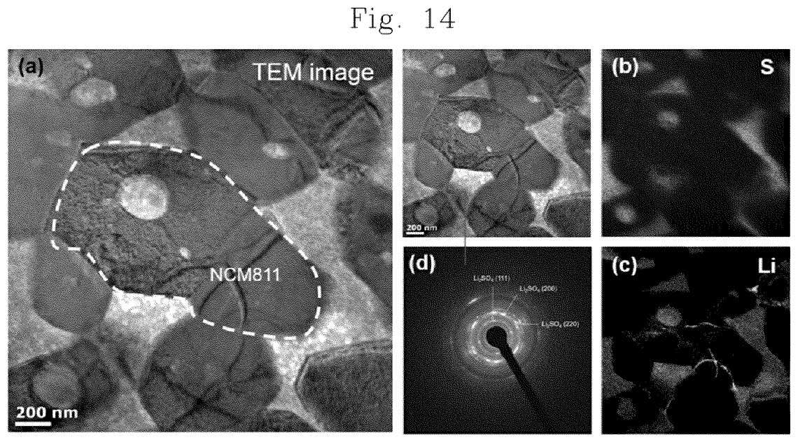

FIG. 13 is a set of photographic images comparing the thermal shock test results of the Example of the present disclosure with those of the Comparative Example,

a of FIG. 13 shows the Comparative Example, and b of FIG. 13 shows the Example of the present disclosure. After fabricating all-solid-state batteries using the composite of the cathode active material (NCM811 coated with the self-assembled monolayer) (140) and the solid electrolyte (LPSCl) for the Example, and the composite of the comparative cathode active material (NCM811) and solid electrolyte (LPSCl) for the Comparative Example, the cells were charged to 4.3 V. Afterward, a thermal abuse test was conducted by exposing each cell to 200° C. in an Ar atmosphere.

As shown in a of FIG. 13, thermal runaway occurs at 200° C. in the composite of the comparative example. In contrast, as shown in b of FIG. 13, thermal runaway does not occur in the composite of the embodiment of the present disclosure. Therefore, it is confirmed that the coating with the self-assembled monolayer 400 according to the embodiment suppresses thermal runaway.

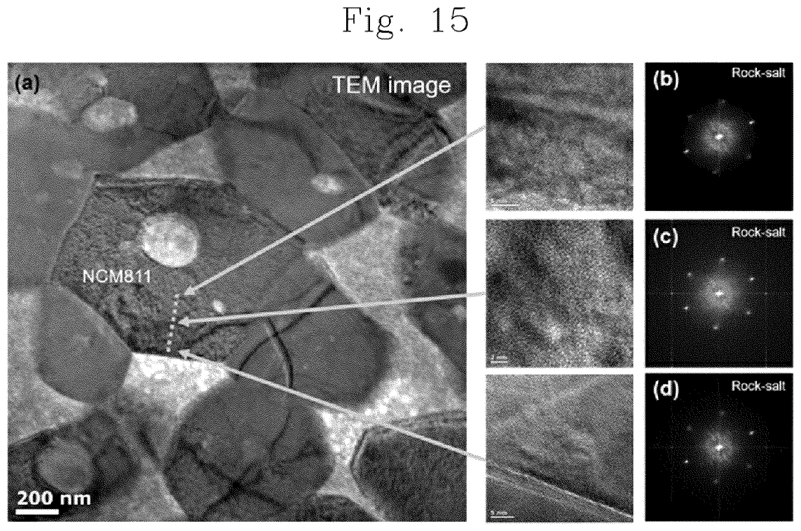

FIG. 14 is a set of photographic images illustrating the TEM analysis results of the composite of the Comparative Example.

As described above, after conducting the thermal shock test, FIB-TEM/EELS analysis of the comparative cathode active material (NCM811) revealed that sulfur (S) infiltrates the grain boundaries (see b of FIG. 14). Lithium ion delithiation was also observed in the infiltrated regions (c of FIG. 14). From SAED analysis of the corresponding matrix, Li₂SO₄ is detected (d of FIG. 14). This indicates that delithiation caused by SO₂ has occurred.

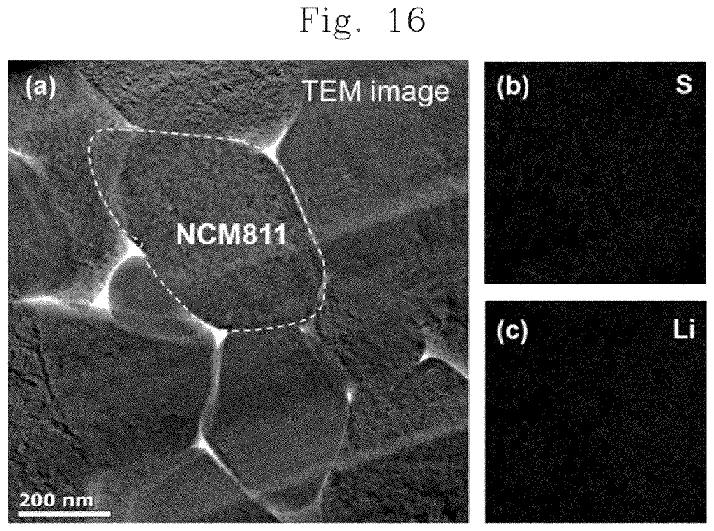

FIG. 15 a set of FFT-converted TEM images of the composite of the Comparative Example.

Referring to b, c and d of FIG. 15, the FFT (fast Fourier transformation) results of the TEM images for the comparative cathode active material (NCM811) show that the layered structure collapses into a rock-salt structure due to lithium-ion delithiation caused by SO₂, indicating degraded structural stability of NCM811.

FIG. 16 is a set of photographic images illustrating the TEM analysis results of the composite according to the Example of the present disclosure.

As described above, after the thermal shock test, FIB-TEM/EELS analysis of the cathode active material (NCM811 coated with the self-assembled monolayer) (140) according to the Example of the present disclosure showed that sulfur (S) and lithium (Li) infiltration at the grain boundaries is not observed (see b and c of FIG. 16).

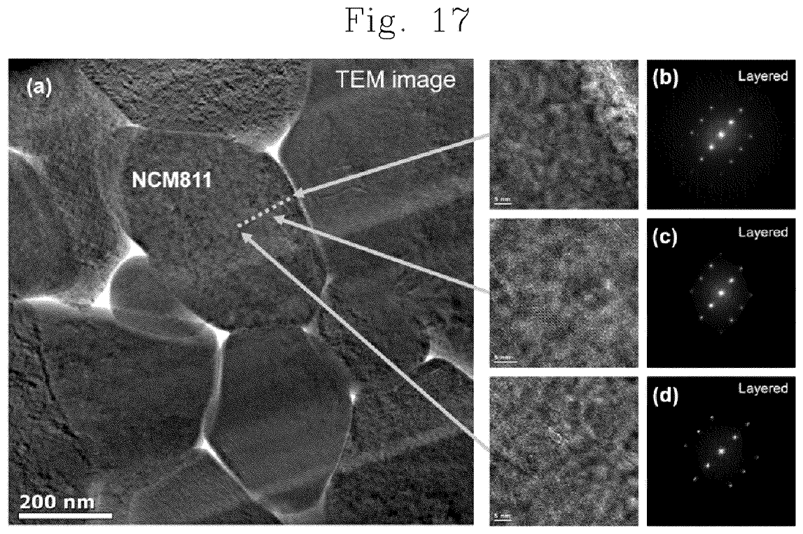

FIG. 17 is a set of FFT-converted TEM images of the composite according to the Example of the present disclosure.

Referring to b, c and d of FIG. 17, the FFT patterns of the TEM images for the cathode active material 140 (NCM811 coated with the self-assembled monolayer) show that the layered structure is preserved at both the surface and interior of the NCM811 grains.

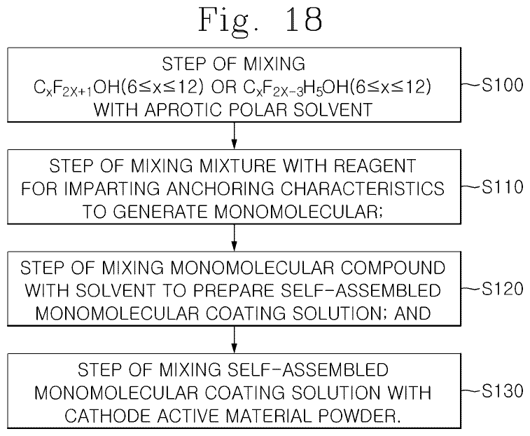

FIG. 18 is a flowchart illustrating the method for manufacturing a cathode active material according to the Example of the present disclosure.

The manufacturing method includes: (A) mixing CₓF₂ₓ₊₂OH (6≤x≤12) or CₓF₂ₓ₋₃H₅OH (6≤x≤12) with an aprotic polar solvent (S100); (B) mixing a reagent for imparting anchoring characteristics with the mixture of step (A) to generate a monomolecular compound (S110); (C) mixing the monomolecular compound with a solvent to prepare a self-assembled monomolecular coating solution (S120); and (D) mixing the self-assembled monomolecular coating solution with a cathode active material powder (S130).

Because the detailed manufacturing method is identical to the description above, redundant explanation is omitted.

Although specific components and limited embodiments have been described for exemplary purposes, the present disclosure is not limited thereto. Various modifications and alterations may be made without departing from the essential spirit of the present disclosure by those skilled in the art. Therefore, the technical spirit of the present disclosure should not be construed as limited to the embodiments described, and all equivalents or equivalent modifications derived from the appended claims fall within the scope of the present disclosure. In addition, the respective embodiments may be combined with one another as needed.

What is claimed is:

1. A cathode active material comprising:
a cathode active material particle capable of intercalating and deintercalating lithium ions; and
a monomolecular compound attached to a surface of the cathode active material particle,
wherein the monomolecular compound comprises:
a functional group containing F;
a spacer comprising CₓF₂ₓ (6≤x≤12) or CₓF₂ₓ₋₄H₄ (6≤x≤12); and
a reactive group including P or Si.

2. The cathode active material of claim 1,
wherein the CₓF₂ₓ or the CₓF₂ₓ₋₄H₄ satisfies the condition of 8≤x≤10.

3. The cathode active material of claim 1,
wherein the CₓF₂ₓ comprises at least one selected from the group consisting of C₈F₁₆, C₉F₁₈, C₁₀F₂₀, C₁₁F₂₂, and C₁₂F₂₄.

4. The cathode active material of claim 1,
wherein the CₓF₂ₓ₋₄H₄ comprises at least one selected from the group consisting of C₈H₄F₁₂, C₉H₄F₁₄, C₁₀H₄F₁₆, C₁₁H₄F₁₈, and
C₁₂H₄F₂₀.

5. The cathode active material of claim 1,
wherein the monomolecular compound forms a self-assembled monolayer, and
a van der Waals interaction between the monomolecular compounds ranges from 32 kJ/mol to 40 kJ/mol.

6. A cathode for an all-solid-state battery,
the cathode comprising a cathode active material and a conductive agent,
wherein the cathode active material is the cathode active material according to claim 1.

7. The cathode of claim 6, wherein the monomolecular compound forms a self-assembled monolayer, and
a van der Waals interaction between the monomolecular compounds ranges from 32 kJ/mol to 40 kJ/mol.

8. The cathode of claim 6, further comprising a cathode current collector.

9. An all-solid-state battery, comprising a cathode, an anode, and a solid electrolyte layer,
wherein the cathode comprises the cathode active material according to claim 1.

10. The all-solid-state battery of claim 9,
wherein the solid electrolyte layer comprises a sulfide-based solid electrolyte.

11. A method for manufacturing a cathode active material, the method comprising:
(A) mixing CₓF₂ₓ₊₁₀H (6≤x≤12) or CₓF₂ₓ₋₃H₅OH (6≤x≤12) with an aprotic polar solvent;
(B) mixing the mixture of step (A) with a reagent for imparting anchoring characteristics to generate a monomolecular;
(C) mixing the monomolecular compound with a solvent to prepare a self-assembled monomolecular coating solution; and
(D) mixing the self-assembled monomolecular coating solution with a cathode active material powder.

12. The method of claim 11, wherein the spacer of the monomolecular compound comprises at least one selected from the group consisting of C₈F₁₆, C₉F₁₈, C₁₀F₂₀, C₁₁F₂₂, C₁₂F₂₄, C₈H₄F₁₂, C₉H₄F₁₄, C₁₀H₄F₁₆, C₁₁H₄F₁₈, and C₁₂H₄F₂₀.

13. The method of claim 11,
wherein the aprotic polar solvent comprises at least one selected from the group consisting of THF (tetrahydrofuran), DMF (dimethylformamide), acetonitrile, and DMSO (dimethyl sulfoxide).

14. The method of claim 11,
wherein the reagent comprises at least one selected from the group consisting of POCl₃ (phosphoryl chloride), KMnO₄, pyridinium chlorochromate, TEMPO (2,2,6,6-tetramethylpiperidine), and a CrO₃/H₂SO₄ mixed reagent.

15. The method of claim 11,
wherein step (B) is performed at a temperature of 0 to 100° C.

16. The method of claim 11,
wherein 15 to 20 mL of the aprotic polar solvent, 300 to 500 mg of the CₓF₂ₓ₊₁OH or CₓF₂ₓ-3H₅OH, and 150 mg to 6 g of the reagent are mixed.

17. The method of claim 11,
wherein when the CₓF₂ₓ₊₁OH or the CₓF₂ₓ₋₃H₅OH is used in an amount of n mol and the reagent is used in an amount of m mol, a molar ratio n/m is 0.5 or less.

18. The method of claim 11,
wherein in step (C), the monomolecular compound is mixed at a concentration of 0.001 to 100 mM with the solvent.

19. The method of claim 18,
wherein the solvent of step (C) comprises THF or a mixed solvent of isopropyl alcohol and an alkane.

20. The method of claim 19,
wherein the alkane comprises at least one selected from the group consisting of hexane (C₆H₁₄), heptane (C₇H₁₆), octane (C₈H₁₈), nonane (C₉H₂₀), decane (C₁₀H₂₂), undecane (C₁₁H₂₄), and dodecane (C₁₂H₂₆).
